(19) United States
(12) Patent Application Publication
(10) Pub. No.: US 2019/0242182 A1
(43) Pub. Date: Aug. 8, 2019

(54) Knock Down Privacy Screen Assembly and Method of Assembling Same

(71) Applicant: L&P Property Management Company, South Gate, CA (US)

(72) Inventors: Thomas J. Newhouse, Grand Rapids, MI (US); Brent J. Ackermann, Pittsboro, NC (US); Dean M. Ferrell, Zeeland, MI (US)

(21) Appl. No.: 15/888,652

(22) Filed: Feb. 5, 2018

(51) Int. Cl. E06B 9/24

(52) U.S. Cl. CPC E06B 9/24

(57) ABSTRACT

A knock down privacy screen assembly is shippable in an unassembled condition. The components include a rectangular knitted privacy screen having a cutout at each corner and pockets along each side of the rectangular knitted privacy screen, hollow frame members and corner members for connecting the hollow frame members. The assembly may be assembled without tools. The assembly may include mounting brackets for securing the assembled privacy screen to a desk or the like. Alternatively, stabilizer feet may be secured to the corner members for supporting the assembled privacy screen on a support surface such as a floor.

### TECHNICAL FIELD

The present invention relates generally to privacy screen assemblies for use in office environments.

### BACKGROUND

Mesh office privacy screens are known. However, such office privacy screens are typically fully assembled at the manufacturer and shipped fully assembled to the customer in large cartons. Non-mesh privacy screens with fabric coverings are also shipped fully assembled.

In today's world of ecommerce, many customers order products on-line and want the product(s) shipped to them at the lowest cost. Because the larger the shipping container, the greater the shipping cost, a privacy screen assembly which may be shipped in a smaller container or containers is desirable.

Many customers want to assembly a product quickly and easily without spending a lot of time. Some may lack the tools necessary for assembly.

Accordingly, there is a need for a knock down privacy screen assembly which may be shipped in a disassembled condition and quickly and easily assembled by the customer.

Furthermore, there is a need for a knock down privacy screen assembly which may be shipped in a disassembled condition and assembled by the customer without tools or with a minimum of tools.

### SUMMARY

According to an exemplary embodiment of the invention, a knock down privacy screen assembly adapted to be shipped in a box in a disassembled condition comprises a generally rectangular knitted privacy screen having a cutout at each corner and pockets along each side of the knitted privacy screen. The knock down privacy screen assembly further comprises first and second hollow frame members, each of the first hollow frame members being a first length and each of the second hollow frame members being a second length less than the first length. Each of the first and second hollow frame members has opposed end portions. Each of the opposed end portions has holes extending through the hollow frame member. The knock down privacy screen assembly further comprises four corner members, each of the corner members being adapted to couple one of the first hollow frame members to one of the second hollow frame members. Each of the corner members has two legs, each of the legs having two push pins adapted to fit into the opposed holes at an end portion of one of the hollow frame members. The knock down privacy screen assembly may be shipped in pieces in a box and assembled quickly and easily on site without requiring special tools.

According to another aspect of the invention, a knock down privacy screen assembly capable of being shipped inside a box in a disassembled condition comprises a one piece knitted privacy screen having a cutout at each corner and pockets along each side of the rectangular knitted privacy screen. The knock down privacy screen assembly further comprises four hollow frame members, some of the hollow frame members being a first length and some of the hollow frame members being a second length less than the first length. The knock down privacy screen assembly further comprises four corner members. Each of the corner members is adapted to couple two of the hollow frame members of different lengths together without fasteners. Each of the corner members has two legs sized to fit inside end portions of the hollow frame members, but the legs lack any push pins. The knitted privacy screen, hollow frame members and corner members of the knock down privacy screen assembly are sized to be shipped in a box and assembled on site without fasteners.

According to another aspect of the invention, a method of assembling a knock down privacy screen assembly shipped in at least one box comprises multiple steps. One step comprises removing a one piece knitted privacy screen from inside a box, the one piece knitted privacy screen having a cutout at each corner and pockets along each side thereof. Another step comprises removing hollow frame members from inside the box, two of the hollow frame members being a first length and two of the hollow frame members being a second length less than the first length. Each of the hollow frame members has opposed holes at each end. Another step comprises passing each of the hollow frame members through one of the pockets of the one piece knitted privacy screen. Another step comprises joining together the hollow frame members together with corner members, each of the corner members joining two of the hollow frame members of different lengths together without fasteners. Each of the corner members has two legs. Each of the legs has two push pins fitting into the opposed holes at one of the end portions of one of the hollow frame members.

Another method of assembling a knock down privacy screen assembly shipped in at least one box comprises removing a one piece knitted privacy screen and hollow frame members from inside a box. The one piece knitted privacy screen has a cutout at each corner and pockets along each side thereof. Two of the hollow frame members are a first length and two of the hollow frame members are a second length less than the first length. An assembler passes one of the hollow frame members through each of the pockets of the one piece knitted privacy screen and joins the hollow frame members together with corner members. Each of the corner members has two legs, each of the legs fitting into an end portion of one of the hollow frame members. Each of the corner members joins two of the hollow frame members of different lengths together without fasteners.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The drawings, which are incorporated in and constitute a part of this specification, illustrate embodiments of the invention and, together with the general description given above and the detailed description given below, explain the embodiments of the invention.

FIG. 1 is a perspective view of the knock down privacy screen assembly in a disassembled condition inside a box.

FIG. 1A is a perspective view of the knock down privacy screen assembly of FIG. 1 in a disassembled condition inside one box and stabilizer feet in another box.

FIG. 2 is a disassembled view of the knock down privacy screen assembly of FIG. 1.

FIG. 2A is an enlarged view of the encircled area 2A of FIG. 2.

FIG. 3A is a perspective view of a portion of the knock down privacy screen assembly of FIG. 1 being assembled.

FIG. 3B is a perspective view of the portion of the knock down privacy screen assembly of FIG. 3A being further assembled.

FIG. 3C is an enlarged perspective view of one of the corner pieces secured to one of the hollow frame members and being secured to another of the hollow frame members.

FIG. 3D is an enlarged perspective view of a different corner piece being secured to different hollow frame members.

FIG. 4 is a perspective view of the knock down privacy screen assembly of FIG. 1 in a fully assembled condition.

FIG. 5 is a perspective view of the assembled knock down privacy screen assembly of FIG. 4 attached to a desk.

FIG. 6 is a cross-sectional view taken along the line 6-6 of FIG. 5.

FIG. 7 is a perspective view of an assembled knock down privacy screen assembly supported by stabilizer feet.

FIG. 8 is a partial disassembled view of a portion of the assembled knock down privacy screen assembly of FIG. 8 showing one stabilizer foot being attached to the frame.

FIG. 8A is a partial disassembled view of a portion of the assembled knock down privacy screen assembly of FIG. 8 showing a different stabilizer foot being attached to the frame.

### DETAILED DESCRIPTION

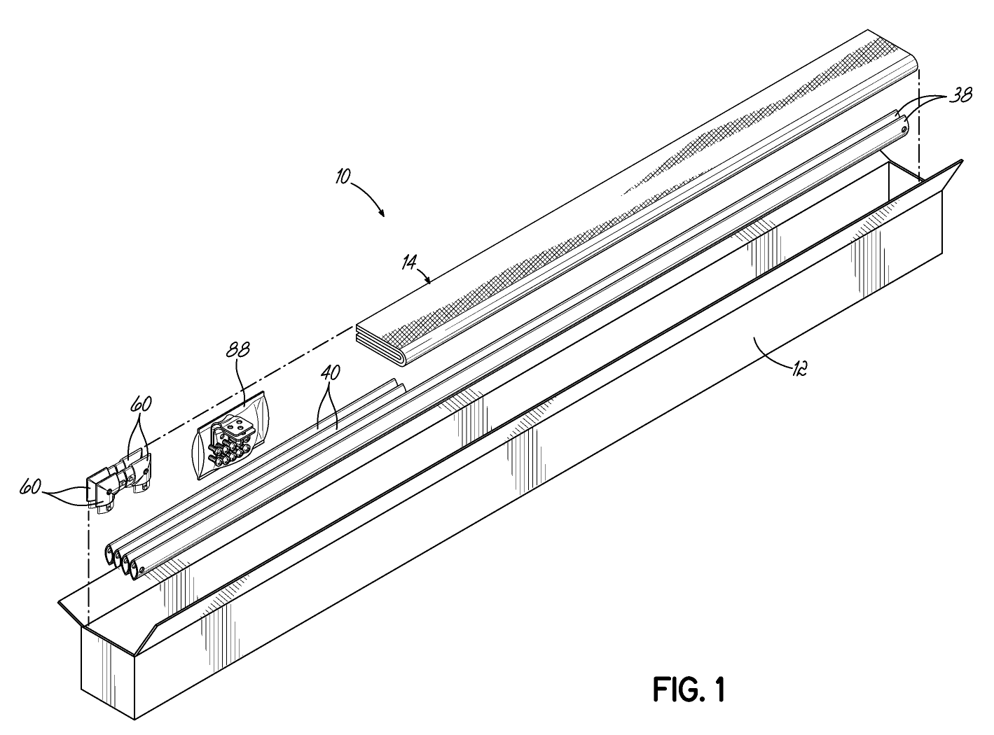

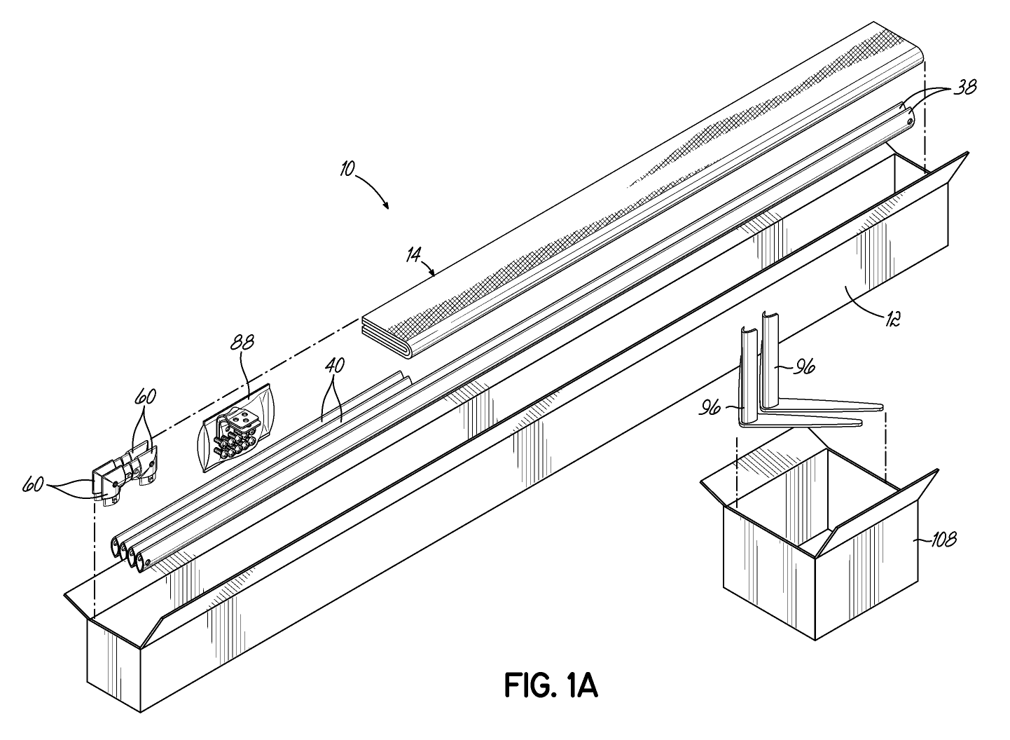

Referring to FIG. 1, a knock down privacy screen assembly 10, according to an exemplary embodiment of the invention, is shown. The privacy screen assembly 10 is shown in a disassembled or knocked down condition inside a box 12.

FIG. 1 illustrates the components of the knock down privacy screen assembly 10 arranged in one configuration for shipping so they fit inside the box 12. However, the drawings are not intended to limit how the components of the knock down privacy screen assembly 10 may be arranged inside the box 12 for shipment; they may be arranged inside the box 12 in any desired manner for shipping.

Similarly, the drawings are not intended to limit how the size or shape of the box 12 used for shipment of the knock down privacy screen assembly 10. The box may be any desired size and shape. The box 12 is preferably made of cardboard, but may be made of any desired material for shipping.

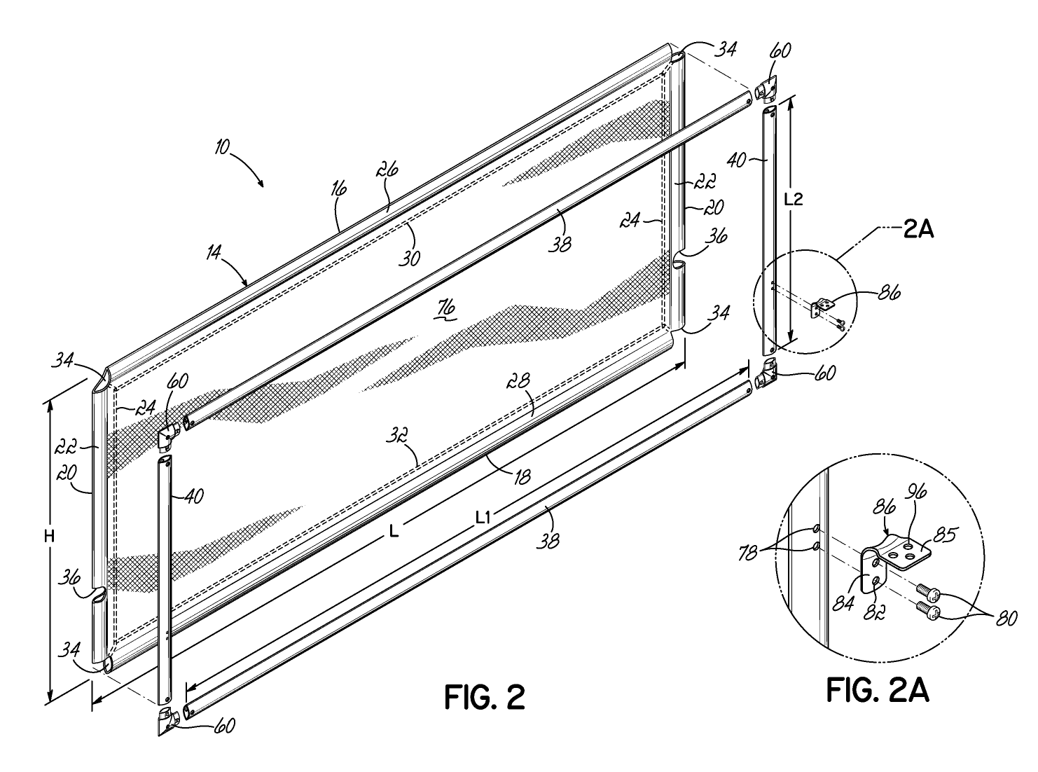

Referring to FIG. 1, the knock down privacy screen assembly 10 comprises a knitted privacy screen 14 in a folded condition. FIG. 2 shows the knitted privacy screen 14 in an unfolded or expanded condition. When in its unfolded or expanded condition, the knitted privacy screen 14 is generally rectangular, having an upper edge 16, a lower edge 18 and opposed side edges 20. The linear distance between the upper and lower edges 16, 18 defines the height H of the knitted privacy screen 14. The linear distance between the side edges 20 defines the length L of the knitted privacy screen 14.

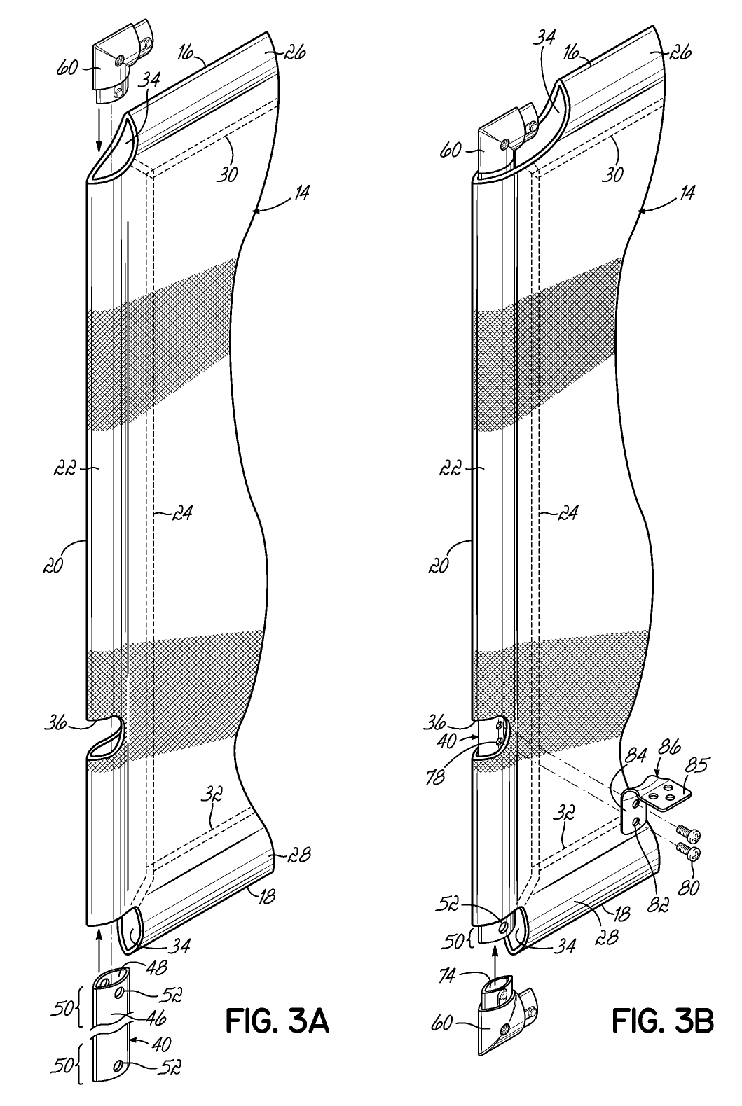

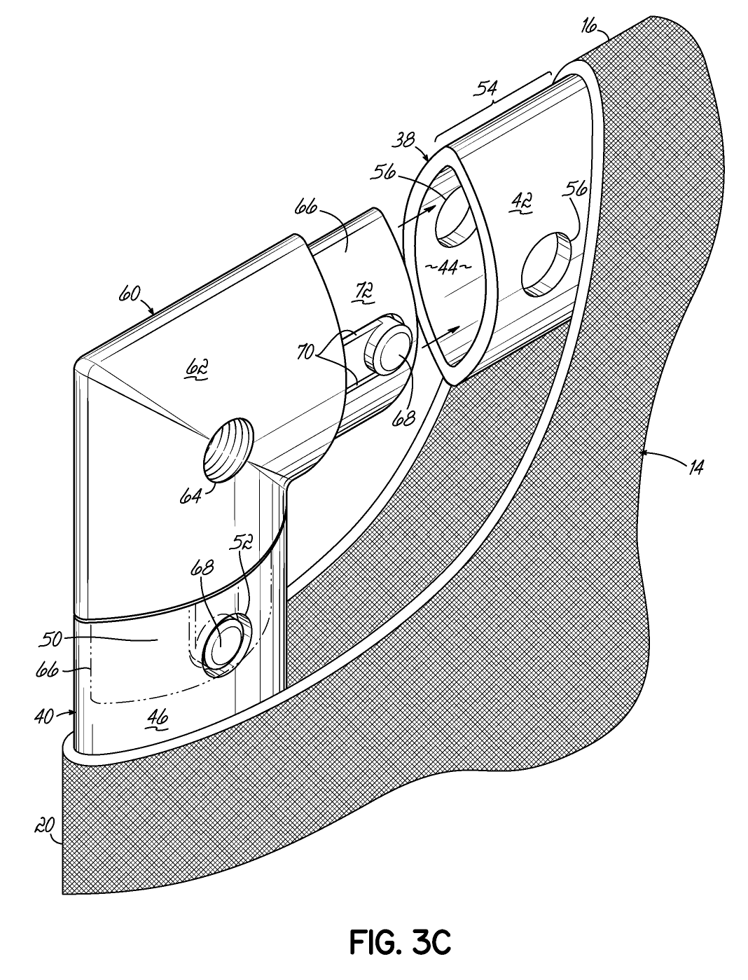

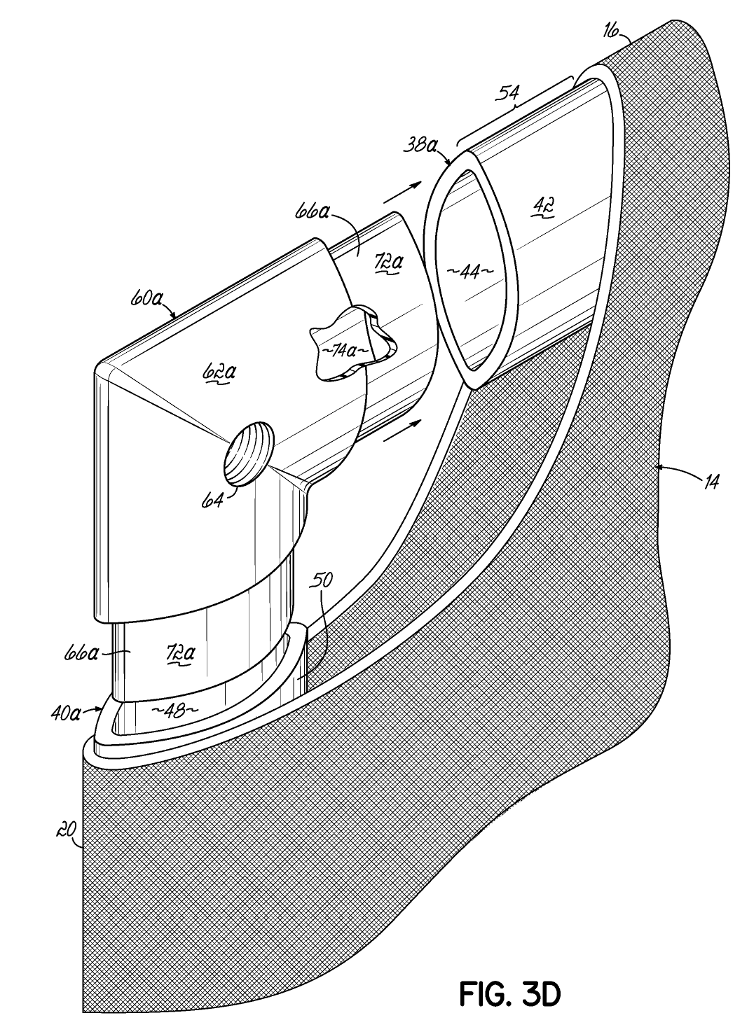

The knitted privacy screen 14 is preferably made from one piece of material, but may be made of any number of pieces of material. The piece of material is folded over itself and sewn together along seams to create pockets along each side of the knitted privacy screen. As best shown in FIGS. 3A and 3B, the knitted privacy screen 14 has opposed side pockets 22, each being defined between a side seam 24 and one of the side edges 20 of the piece of material. Likewise, the knitted privacy screen 14 has upper and lower pockets 26, 28. The upper pocket 26 is defined between an upper seam 30 and the upper edge 16 of the piece of material. The lower pocket 28 is defined between a lower seam 32 and the lower edge 18 of the piece of material.

As best shown in FIGS. 2, 3A and 3B, a cutout 34 is located at each corner of the knitted privacy screen 14 to allow hollow frame members described below to enter and/or exit one the pockets 22, 26 and 28 of the knitted privacy screen 14. In each of the four cutouts 34, some of the material of the knitted privacy screen 14 is removed.

As best shown in FIGS. 2, 3A and 3B, a notch 36 is located along each of the side pockets 22 of the knitted privacy screen 14 to allow access to side hollow frame members 40 located inside the side pockets 22 of the knitted privacy screen 14. In each of the two notches 36, some of the material of the side pocket 22 of the knitted privacy screen 14 is removed. Although the drawings illustrate the notches 36 being in a specific location, the notches 36 may be located at other positions along the side pockets 22 of the knitted privacy screen 14. Each of the notches 36 serves to provide easy access to one of the side hollow frame members as described below to secure a mounting bracket 86 to the side hollow frame member 40, as shown in FIG. 3B.

As best illustrated in FIG. 2, the knock down privacy screen assembly 10 further comprises four hollow frame members including two first hollow frame members 38 and two second or side hollow frame members 40. As shown in FIG. 2, each of the first hollow frame members 38 has a first length L1 and each of the second or side hollow frame members 40 has a second length L2 which is less than the first length L1. As best shown in FIG. 3C, each of the first hollow frame members 38 has a wall 42 which is generally oval or eye-shaped inside which is a hollow interior 44. Similarly, as best shown in FIGS. 3A and 3B, each of the second or side hollow frame members 40 has a wall 46 which is generally oval or eye-shaped inside which is a hollow interior 48.

As best shown in FIGS. 3A and 3B, each of the second or side hollow frame members 40 has two opposed end portions 50. Each end portion 50 has two aligned openings 52, one on each side of the second or side hollow frame member 40 and extending through the wall 46 of the second or side hollow frame member 38. Although each opening 52 is illustrated being circular, it may be any desired size or shape.

As best shown in FIG. 3C, each of the first hollow frame members 38 has two opposed end portions 54 (only one being shown). Each end portion 54 has two aligned openings 56, one on each side of the first hollow frame member 38 and extending through the wall 42 of the first hollow frame member 38. Although each opening 56 is illustrated being circular, it may be any desired size or shape.

As best shown in FIG. 1, the knock down privacy screen assembly 10 further comprises four identical corner members 60. FIGS. 3A-3C illustrate one version of corner member 60 having push pins 68 for securing corner member 60 to one of the first hollow frame members 38 and one of the second or side hollow frame members 40 without using any fasteners. The corner members 60 are adapted for use with the first and second hollow frame members 38, 40 having end portions 54, 50, respectively.

As best shown in FIG. 3C, each corner member 60 is an injection molded unitary member comprising a center section 62 having a threaded hole 64 extending through the center section 62. Each corner member 60 further comprises two legs 66, extending at right angles to each other outwardly from the center section 62. In other words, the legs 66 are integral with the central section 62 and orthogonal to each other. Each leg 66 has two push pins 68 integral with the material of the leg 66. Two cuts 70 in the material of the leg 66 allow each of the push pins 68 to be pushed in with force exerted by a person to allow the leg 66 to fit within either the hollow interior 44 of one of the first hollow frame members 38 or the hollow interior 48 of one of the second or side hollow frame members 40. Each of the legs 66 of each of the corner members 60 has a wall 72 which is generally oval or eye-shaped inside which is a hollow interior 74 which allows movement of the two push pins 68 of each leg 66 towards each other. See FIG. 3B.

Each leg 66 of each corner member 60 is sized to fit within either the hollow interior 44 of one of the first hollow frame members 38 or the hollow interior 48 of one of the second or side hollow frame members 40. To secure one of the legs 66 of one of the corner members 60 to one of the first hollow frame members 38 or one of the second or side hollow frame members 40, an operator pushes the push pins 68 of the leg 66 towards each other and slides the leg 66 inside either the hollow interior 44 of one of the first hollow frame members 38 or the hollow interior 48 of one of the second or side hollow frame members 40. The inherent outward bias of each of the push pins 68 of the leg 66 pushes each push pin 68 through one of the openings 52 of one of the second or side hollow frame members 40 or through one of the openings 56 of one of the first hollow frame members 38. The inherent bias of the push pins 68 after the push pins 68 extend through respective openings 52 or 56 locks the corner member 60 to one of the first or second hollow frame members 38, 40. Thus, each of the four corner members 60 secures one of the first hollow frame members 38 and one of the second or side hollow frame members 40 in position perpendicular to each other.

FIG. 3C shows one of the second or side hollow frame members 40 locked to a downwardly directed leg 66 of a corner member 60, the push pins 68 of the downwardly directed leg 66 extending through the openings 52 of one of the end portions 50 of one of the second or side hollow frame members 40 (only one being shown). FIG. 3C shows the other leg 66 of the corner member 60 moving towards one of the end portions 54 of one of the first hollow frame members 38 to engage the push pins 68 (only one being shown) of the other leg 66 of the corner member 60 within the openings 56 of the end portion 54 of the first hollow frame member 38.

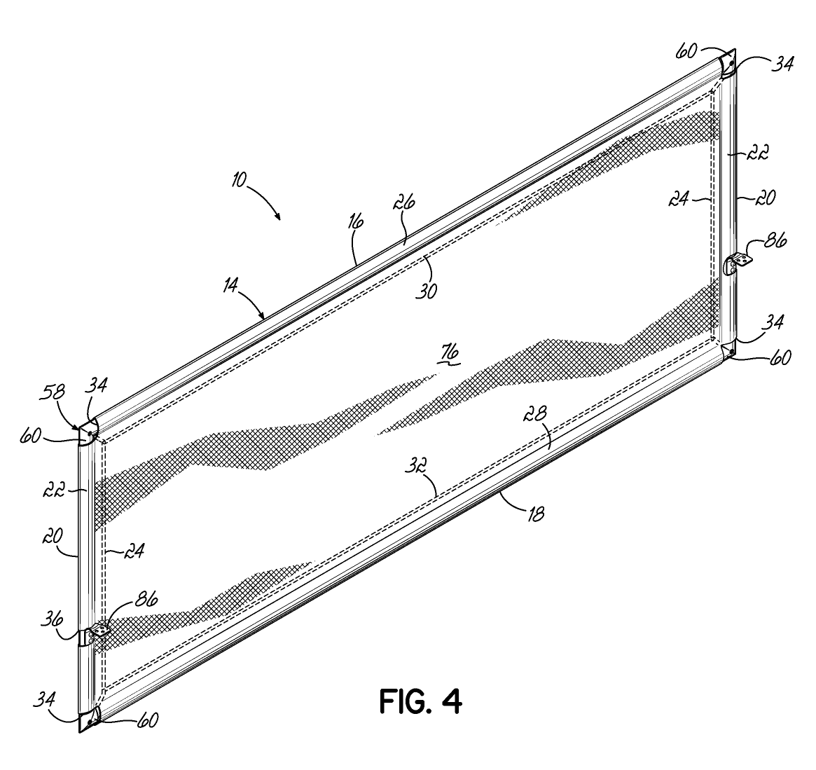

To assemble a frame 58 with the knitted privacy screen 14 supported by the fully assembled frame 58, each of the four corner members 60 must be secured to one of the first hollow frame members 38 and one of the second or side hollow frame members 40 using the push pins 68 as described above. Each of the first and second hollow frame members 38, 40 must have openings through which the push pins 68 of the corner members 60 may extend. FIG. 4 illustrates a generally rectangular fully assembled frame 58 supporting the knitted privacy screen 14, the first and second hollow frame members 38, 40 extending through the pockets 22, 26, 28 of the knitted privacy screen 14 and secured together with the corner members 60. As best shown in FIG. 4, a generally planar central portion 76 of the knitted privacy screen 14 is located within the side seams 22, upper seam 30 and lower seam 32.

To knock down or disassemble the fully assembled frame 58 supporting the knitted privacy screen 14, a person or operator must push in opposed push pins 68 of one of the legs 66 of one of the corner members 60 and pull apart the corner member 60 from one of the first and second hollow frame members 38, 40 which had been surrounding the leg 66 of the corner member 60. The opposed push pins 68 of the respective leg 66 of the respective corner member 60 thus disengage from the openings in the respective hollow frame member 38, 40. This process is done one leg of one corner member 60 at a time until the corner members 60 may be full separated from the first and second hollow frame members 38, 40.

FIG. 3D illustrates another embodiment or version of corner member 60a which lacks push pins. Each of the corner members 60a (only one being shown) of this embodiment of fully assembled frame 58a is identical to corner member 60 shown in FIG. 3C, but without the push pins. As shown in FIG. 3D, each of the corner members 60a is used with two identical first hollow frame members 38a and two identical second or side hollow frame members 40a to complete a fully assembled frame 58a supporting the knitted privacy screen 14. Each of the first hollow frame members 38a is identical to first hollow frame member 38 but lacks openings 56. Similarly, each of the second or side hollow frame members 40a is identical to second or side hollow frame member 40 but lacks openings 52.

Each of the corner members 60a (only one being shown) is an injection molded unitary member comprising a center section 62a having a threaded hole 64 extending through the center section 62a. Each corner member 60a further comprises two legs 66a, extending at right angles to each other from the center section 62a. In other words, the legs 66a are integral with the central section 62a and orthogonal to each other. Each leg 66a is sized to fit within either the hollow interior 44 of one of the first hollow frame members 38a or the hollow interior 48 of one of the second or side hollow frame members 40a. Each of the legs 66a of each of the corner members 60a has a wall 72a which is generally oval or eye-shaped inside which is a hollow interior 74a, like the legs 66 of corner members 60 shown in FIG. 3B.

To secure one of the legs 66a of one of the corner members 60a to one of the first hollow frame members 38a or one of the second or side hollow frame members 40a, an operator slides the leg 66a inside the either the hollow interior 44 of one of the first hollow frame members 38a or the hollow interior 48 of one of the second or side hollow frame members 40a.

As best shown in FIG. 2A, each of the second or side hollow frame members 40 has two spaced threaded openings 78 adapted to receive fasteners 80 shown as screws. The fasteners 80 are sized to fit through passages 82 in one of the arms 84, 85 of an L-shaped mounting bracket 86. Although not shown, each of the second or side hollow frame members 40a may have two spaced threaded openings for securing one of the L-shaped mounting brackets 86 thereto.

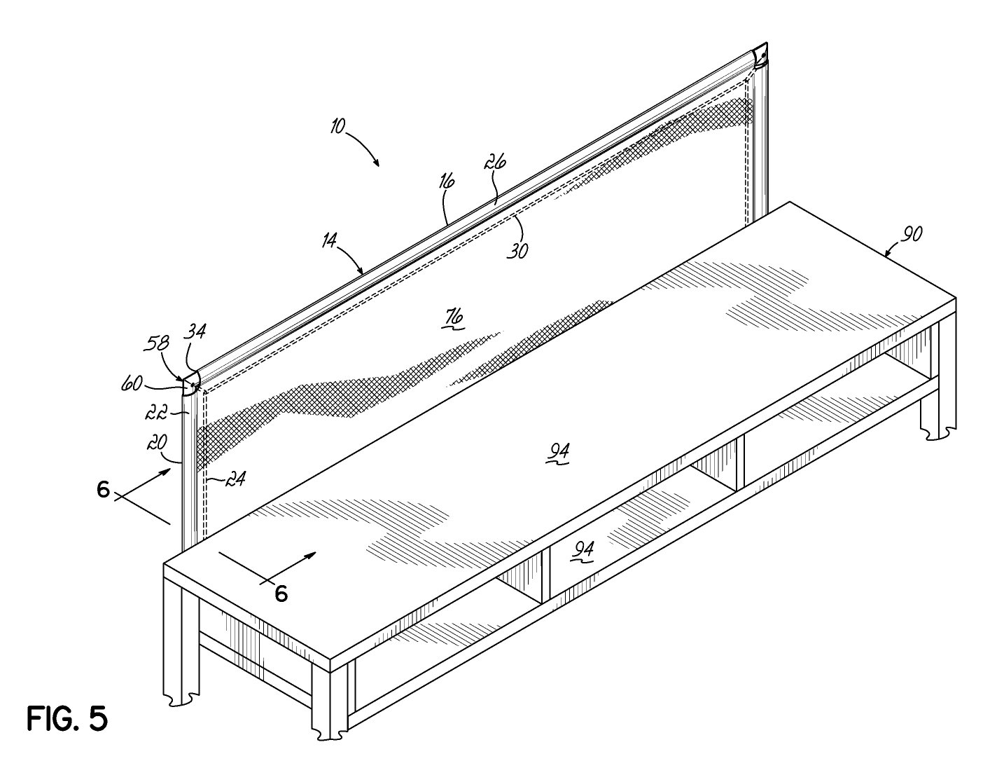

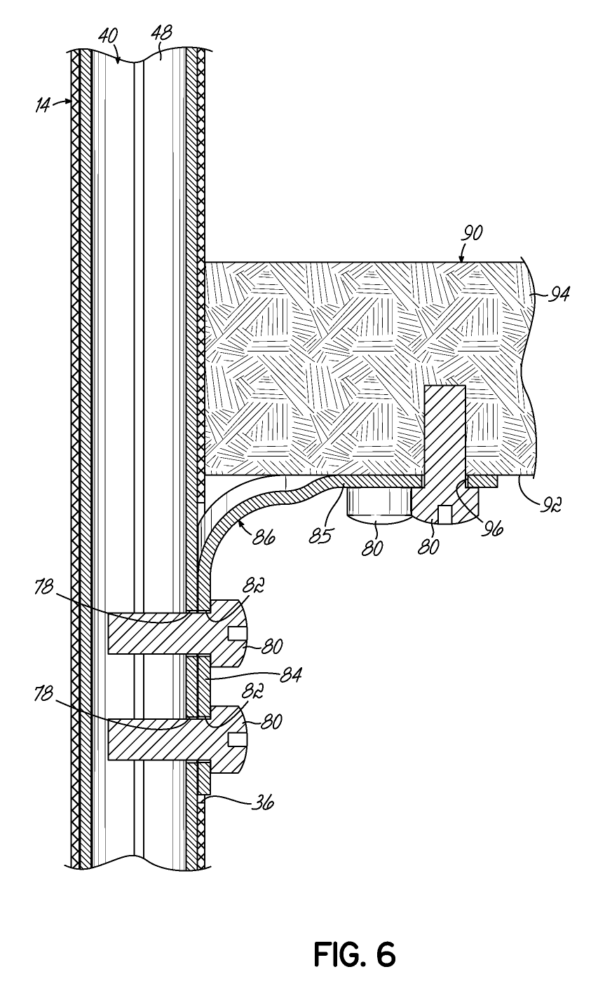

As shown in FIGS. 5 and 6, a mounting kit 88 comprising two L-shaped mounting brackets 86 and four fasteners 80 may be used to secure an assembled knock down privacy screen assembly 10 to a desk 90. As shown in FIG. 6, additional fasteners 80 may be used to secure the other arm 85 of each L-shaped mounting bracket 86 to a lower surface 92 of a horizontal shelf 94 of the desk 90. As best shown in FIG. 2A, arm 85 of each L-shaped mounting bracket 86 is illustrated having three passages 96 through which the fasteners 80 pass to secure the assembled knock down privacy screen assembly 10 to the horizontal shelf 94 of the desk 90. Although a desk is illustrated, L-shaped mounting brackets 86 may be used to secure the assembled knock down privacy screen assembly 10 to any piece of furniture. Although one style of L-shaped mounting bracket 86 is shown, the drawings are not intended to be limiting. Any known mounting brackets may be used.

As best shown in FIG. 1, two L-shaped mounting bracket 86 and ten fasteners 80 are included in a plastic bag for shipping purposes and referred to as mounting kit 88. However, any number of known mounting brackets and fasteners may be included in such a mounting kit.

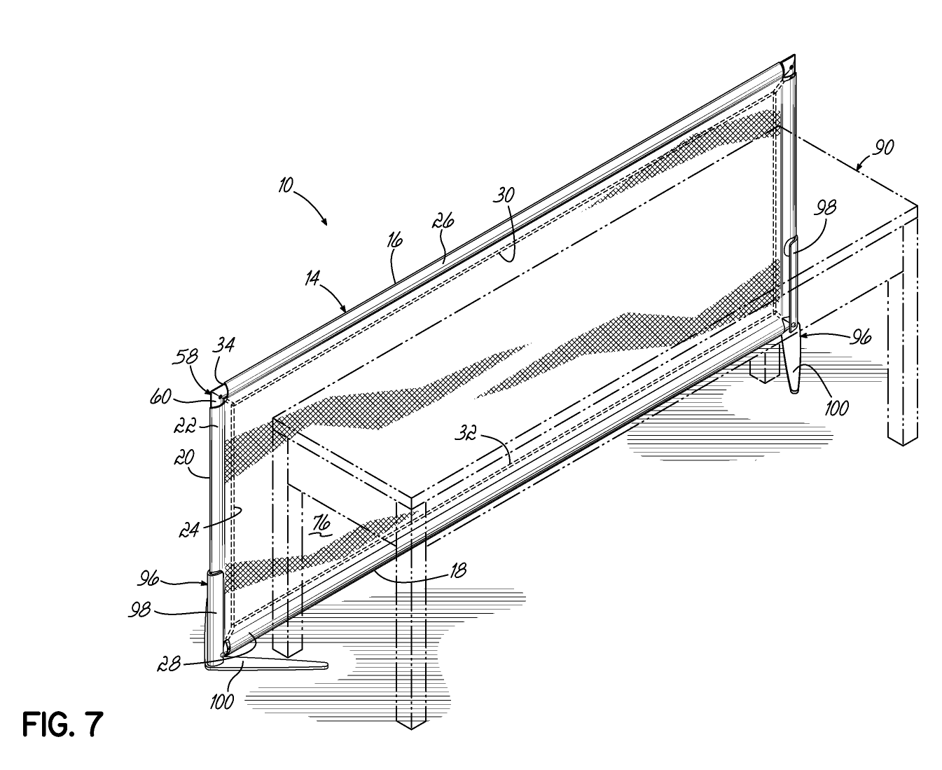

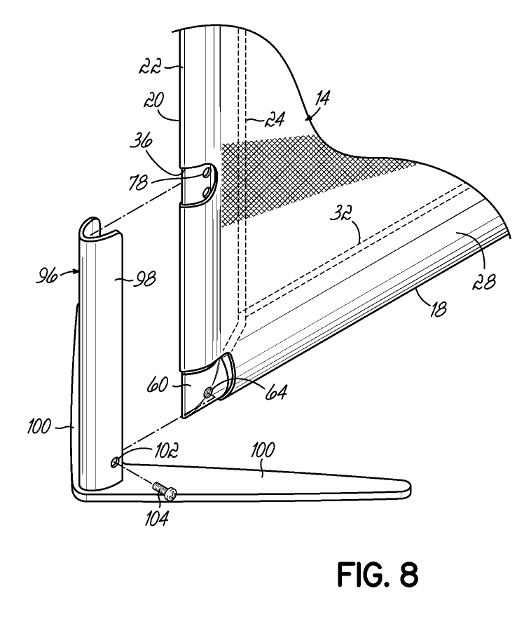

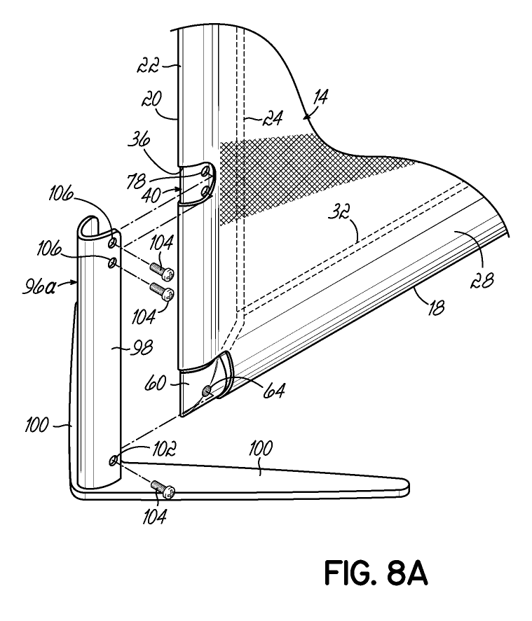

FIGS. 7, 8 and 8A illustrate other ways to keep a fully assembled knock down privacy screen assembly 10 upright to serve its purpose of providing privacy. FIGS. 7 and 8 illustrate two stabilizer feet 96, each stabilizer foot 96 being secured to one side of the fully assembled knock down privacy screen assembly 10. As shown in FIG. 8, each stabilizer foot 96 is identical and adapted to be secured to one of the corner members 60, 60a. Although FIG. 8 shows one stabilizer foot 96 being secured to a corner member 60, each stabilizer foot 96 may be secured to one of the corner members 60, 60a in the same manner.

As shown in FIG. 8, each stabilizer foot 96 comprises a shell 98 and two legs 100. The legs 100 are illustrated as being generally horizontal, generally orthogonal to each other and adapted to rest upon a support surface, shown as a floor in FIG. 7. The legs 100 may rest upon the floor of a building or any other support surface. The shell 98 is generally U-shaped in cross-section and adapted to fit over one of the second or side hollow frame members 40 and fabric pocket covering of the knitted privacy screen.

As shown in FIG. 8, the shell 98 has a threaded opening 102 adapted to align with one of the threaded openings 64 of one of the corner members 60 or 60a. A threaded fastener in the form of a screw 104 is engaged with both threaded openings 102 of the stabilizer foot 96 and threaded opening 64 of one of the corner members 60 or 60a to secured the stabilizer foot 96 in place.

FIG. 8A illustrates another embodiment or version of stabilizer foot 96a which is identical to stabilizer foot 96 but has two additional threaded openings 106 in its shell 98. Additional threaded fasteners in the form of screws 104 are engaged with threaded openings 106 of the stabilizer foot 96a and threaded openings 78 of one of the second or side hollow frame members 40 or 40a to further secure or stabilize the stabilizer foot 96a in place.

As shown in FIG. 1A, the two stabilizer feet 96 may be shipped in a second box 108 which may be cardboard or any desired material. If stabilizer feet 96a are desired, they may be shipped the same way.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A knock down privacy screen assembly adapted to fit into a box, the knock down privacy screen assembly comprising:
a generally rectangular knitted privacy screen having a cutout at each corner and pockets along each side of the knitted privacy screen;
first and second hollow frame members, each of the first hollow frame members being a first length and each of the second hollow frame members being a second length less than the first length, each of the first and second hollow frame members having opposed end portions, each of the opposed end portions having holes extending through the hollow frame member; and
four corner members, each of the corner members being adapted to couple one of the first hollow frame members to one of the second hollow frame members, each of the corner members having two legs, each of the legs having two push pins adapted to fit into the opposed holes at an end portion of one of the hollow frame members,
wherein the knock down privacy screen assembly may be shipped in pieces in a box and assembled on site.

2. The knock down privacy screen assembly of claim 1, wherein each of the first and second hollow frame members is made of aluminum.

3. The knock down privacy screen assembly of claim 1, wherein each of the corner members is made of plastic.

4. The knock down privacy screen assembly of claim 1, further comprising stabilizer feet.

5. The knock down privacy screen assembly of claim 1, further comprising brackets and fasteners for securing the second hollow frame members to a piece of furniture.

6. The knock down privacy screen assembly of claim 1, further comprising brackets and fasteners for securing the knock down privacy screen assembly once assembled to a piece of furniture.

7. The knock down privacy screen assembly of claim 1, wherein each of the corner members has a threaded hole therein adapted to receive a stabilizer foot.

8. A knock down privacy screen assembly capable of being shipped inside a box in a disassembled condition, the knock down privacy screen assembly comprising:
a one piece knitted privacy screen having a cutout at each corner and pockets along each side of the rectangular knitted privacy screen;
four hollow frame members, some of the hollow frame members being a first length and some of the hollow frame members being a second length less than the first length; and
four corner members, each of the corner members adapted to couple two of the hollow frame members of different lengths together without fasteners, each of the corner members having two legs sized to fit inside end portions of the hollow frame members,
wherein the knitted privacy screen, hollow frame members and corner members of the knock down privacy screen assembly are sized to be shipped in a box and assembled on site without fasteners.

9. The knock down privacy screen assembly of claim 8, wherein each of the legs of each of the corner members has push pins adapted to fit into opposed holes extending through end portions of each of the hollow frame members.

10. The knock down privacy screen assembly of claim 9, wherein each of the push pins is integral with one of the corner members.

11. The knock down privacy screen assembly of claim 8, further comprising stabilizer feet for securement to the corner members.

12. The knock down privacy screen assembly of claim 8, further comprising L-shaped brackets and fasteners for securing the knock down privacy screen assembly once assembled to a piece of furniture.

13. The knock down privacy screen assembly of claim 12, wherein each of the L-shaped brackets is adapted to be secured to one of the hollow frame members.

14. The knock down privacy screen assembly of claim 11, wherein each of the corner members has a threaded hole therein adapted to receive a stabilizer foot.

15. A method of assembling a knock down privacy screen assembly shipped in at least one box, the method comprising:
removing a one piece knitted privacy screen from inside a box, the one piece knitted privacy screen having a cutout at each corner and pockets along each side thereof;
removing hollow frame members from inside the box, two of the hollow frame members being a first length and two of the hollow frame members being a second length less than the first length, each of the hollow frame members having opposed holes at each end;
passing each of the hollow frame members through one of the pockets of the one piece knitted privacy screen; and
joining together the hollow frame members together with corner members, each of the corner members joining two of the hollow frame members of different lengths together without fasteners, each of the corner members having two legs, each of the legs having two push pins fitting into the opposed holes at one of the end portions of one of the hollow frame members.

16. The method of claim 15, further comprising securing stabilizer feet to the corner members.

17. The method of claim 15, further comprising securing L-shaped brackets to opposed hollow frame members.

18. A method of assembling a knock down privacy screen assembly shipped in at least one box, the method comprising:
removing a one piece knitted privacy screen and hollow frame members from inside a box, the one piece knitted privacy screen having a cutout at each corner and pockets along each side thereof and two of the hollow frame members being a first length and two of the hollow frame members being a second length less than the first length;
passing one of the hollow frame members through each of the pockets of the one piece knitted privacy screen; and
joining together the hollow frame members together with corner members, each of the corner members having two legs, each of the legs fitting into an end portion of one of the hollow frame members, each of the corner members joining two of the hollow frame members of different lengths together without fasteners.

19. The method of claim 15, further comprising unfolding the one piece knitted privacy screen after the one piece knitted privacy screen is removed from inside the box.

20. The method of claim 15, each of the hollow frame members has opposed holes at each end portion thereof and each of the legs of each corner member has push pins sized to fit into the opposed holes at one of the end portions of one of the hollow frame members, wherein joining together the hollow frame members together with corner members comprises inserting the push pins of the corner members into the opposed holes of the hollow frame members.
